(19) United States
(12) Patent Application Publication
(10) Pub. No.: US 2007/0143451 A1
(43) Pub. Date: Jun. 21, 2007

(54) System and method for configuring a control system

(75) Inventors: William A. Huth, Hartland, WI (US); John C. Ignasiak, New Berlin, WI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 11/312,625

(22) Filed: Dec. 20, 2005

(51) Int. Cl. G06F 15/177

(52) U.S. Cl. 709/220; 700/275

(57) ABSTRACT

A system for configuring a building automation control system includes a user interface configured to receive system data regarding specifications for the building automation control system from a user. Configuration logic is coupled to the user interface and is used to generate at least one view of the building automation control system. Packaging logic is coupled to the user interface and is used to generate at least one deliverable. A common data storage system is coupled to the configuration logic and the packaging logic. The data storage system is commonly accessible to the configuration logic and the packaging logic and includes a set of predefined preferences. The at least one view is generated based on at least the system data and the predefined preferences.

### FIELD OF THE INVENTION

The present invention relates generally to the field of control systems and in particular to a system and method for configuring, designing and implementing a control system such as a building automation control system.

### BACKGROUND OF THE INVENTION

Non-residential buildings or facilities (e.g., retail stores, manufacturing plants, office buildings, university campus buildings, school buildings, health care facilities, governmental buildings, sports complexes and so on) and their related subsystems such as heating, ventilation, and air conditioning (HVAC), security, fire, power management, parking structure management, elevator control, energy management, and the like are managed using a variety of automated systems (e.g., a Building Automation System (BAS)) and onsite staff.

The design and implementation of a control system, e.g., a Building Automation System, and it various subsystems may include various phases such as an engineering/configuration phase, a packaging/installation phase and a commissioning phase. In an engineering/configuration phase, aspects of the control system are configured including hardware systems, subsystems and assemblies to define the systems and equipment that will be needed. In a packaging/installation phase, packages of materials (e.g., wiring diagrams) that will be used during installation are generated. In a commissioning phase, the control system is evaluated to ensure that the installed system is operating properly. Typically, each phase is implemented using a separate system or tool. The different tools may not communicate with each other resulting in the need for re-entry of information which may be inefficient and increase the chance for error.

What is needed is a system to configure a control system that includes a common database for all phases of configuring and implementing the control system. Data or information in the database would be available to all phases or tasks performed by the system to configure the control system. It would also be desirable to provide a system to configure a control system that includes high level user interfaces and a relational database used to automatically generate views, diagrams or deliverables for the control system. The database may include predefined preferences which may be used in conjunction with specification provided by a user to select specific parts or systems.

### SUMMARY OF THE INVENTION

In accordance with one embodiment, a system for configuring a building automation control system includes a user interface configured to receive system data regarding specifications for the building automation control system from a user, configuration logic coupled to the user interface and configured to generate at least one view of the building automation control system, packaging logic coupled to the user interface and configured to generate at least one deliverable and a common data storage system coupled to the configuration logic and the packaging logic, the data storage system begin commonly accessible to the configuration logic and the packaging logic and including a set of predefined preferences, wherein the at least one view is generated based on at least the system data and the predefined preferences.

In accordance with another embodiment, a system for configuring a building automation control system includes a user interface configured to receive system data regarding specifications for the building automation control system from a user, control applications engineering logic coupled to the user interface and configured to generate control systems for the building automation control system, customer interface engineering logic coupled to the user interface and configured to generate at least one customer interface for the building automation control system, and a common data storage system coupled to the control applications engineering logic and the customer interface engineering logic, the data storage system begin commonly accessible to the configuration logic and the packaging logic and including a set of predefined preferences, wherein the control systems are generated based on at least the system data and the predefined preferences.

### BRIEF DESCRIPTION OF THE DRAWINGS

The invention will be more readily understood by reference to the following description taken with the accompanying drawings, in which:

FIG. 1 is a block diagram of a system for configuring a control system in accordance with an embodiment.

FIG. 2 is illustrates an exemplary system selection tool in accordance with an embodiment.

FIG. 3 is a block diagram of the configuration/engineering logic in accordance with an embodiment.

FIG. 4 is an exemplary hardware diagram view in accordance with an embodiment.

FIG. 5 is an exemplary control diagram view in accordance with an embodiment.

### DETAILED DESCRIPTION OF THE PREFERRED EMBODIMENTS

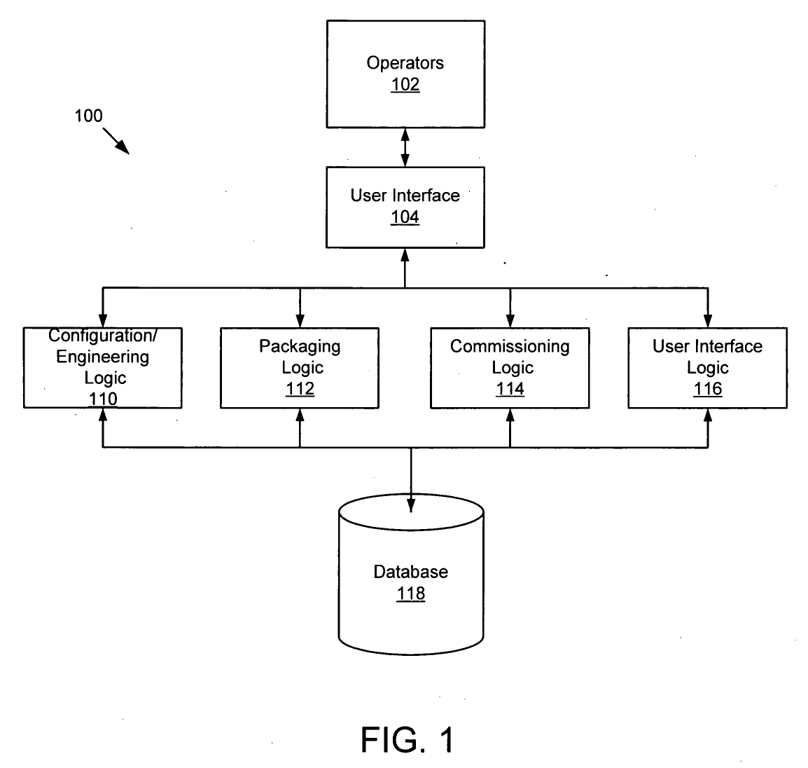

FIG. 1 is a block diagram of a system for configuring a control system in accordance with an embodiment. In an exemplary embodiment, system 100 is used to configure a building automation control system and associated subsystems (e.g., a heating, ventilation and air conditioning (HVAC) system, a security system, a power management system, etc.) for a facility. The following description will refer to an exemplary system to configure a building automation control system, however, it should be understood that systems and methods for configuring a control system described herein may be used in conjunction with other types of control systems.

System 100 includes a user interface 104, configuration/engineering logic 110, packaging logic 112, commissioning logic 114, user interface logic 116 and database 118. System 100 is configured to implement various phases of a building automation control system including a configuration/engineering phase, a packaging/installation phase and a commissioning phase. It will be appreciated that system 100 may perform fewer or additional functions as compared to those described herein.

Elements of system 100 may be implemented on a computer system utilizing existing computer capabilities, both hardware and software, and electronic communication links to, for example, receive and process data provided by a user or operator 102. System 100 may include computer servers. The various elements of system 100 may be implemented on a single computer or on multiple computer systems. Elements of system 100 may be operated by the same or different entities and may be implemented on a separate logical servers or using separate physical devices. The computer systems or servers may operate under the control of computer software to carry out the process steps described herein. Computer software may include a set of software objects and/or program elements collectively having the ability to execute independently in a separate thread or logical chain of process evaluation, while permitting the flow of data inputs therebetween. Data may be communicated between the various elements of system 100 in real time over a computer network. Various embodiments may be implemented in a variety of environments including a single computer system, intranets, local area networks, the Internet, wide area networks, communication networks, dial-up services, wireless, etc. Computers implementing system 100 may include a screen display to display, for example, screens of user interface 104 and to view outputs and an operator input device (e.g., a keyboard) to allow data in system 100 to be manipulated (e.g., via inputs from a user or operator 102) and any output to be viewed, stored, and communicated to other systems.

User interface 104 and user interface logic 116 provide a user interface to system 100. User interface 104 is configured to access the various elements of system 100. A user 102 may access the elements of system 100 through the Internet, an intranet or a local area network by using a desktop or laptop computer or other suitable Internet-enabled device. In addition, all logic data could reside on a desktop/laptop computer, e.g., a shadow copy of the data stored on a network is processed locally and then updated on the network. In one embodiment, elements of system 100 may be accessible to users 102 by utilizing user interface 104 to access a Web site or portal and clicking on the appropriate links located at the Web site or portal. Elements of system 100 may be made available via a secure link to the Internet, e.g., a secure link to a Web site. User interface logic 116 may be used in conjunction with configuration/engineering logic 110, packaging logic 112 and commissioning logic 114 to generate the appropriate display to a user 102 via user interface 104.

Database 118 is coupled to configuration/engineering logic 110, packaging logic 112 and commissioning logic 114. Database 118 is a common database used in all phases of configuring and implementing a building automation control system. Accordingly, database 118 may be accessed by each of the various elements of system 100. Preferably, database 118 is a relational database. Database 118 is configured to store data regarding a plurality (or library) of products/systems (e.g., parts, equipment, controllers, control logic, control system, control diagrams, etc.), a specification for each product/system, details of configured building automation control systems, data provided by a user 102 (e.g., system specifications) and pre-stored preferences. Database 118 includes data received or generated during operation of each of the subsystems/elements of system 100. Accordingly, data in database 118 is available to each user during each phase of configuring and implementing a building automation system. Once data or changes are entered during one phase and stored in database 118, it is automatically made available to all subsequent phases and during different subtasks of the same phase.

The pre-stored preferences in database 118 may be created by a user or administrator of system 100. Preferences may be associated with a particular user and relate to, for example, preferences for specific control systems, parts, types of parts, etc. Preferences may be established for a particular region, location, climate, country, customer, type of customer, market, etc. Preferences may be used during the configuration/engineering phase to, for example, select specific parts or equipment preferred for a particular climate or to select a particular control diagram preferred for a particular type of customer (e.g., type of facility).

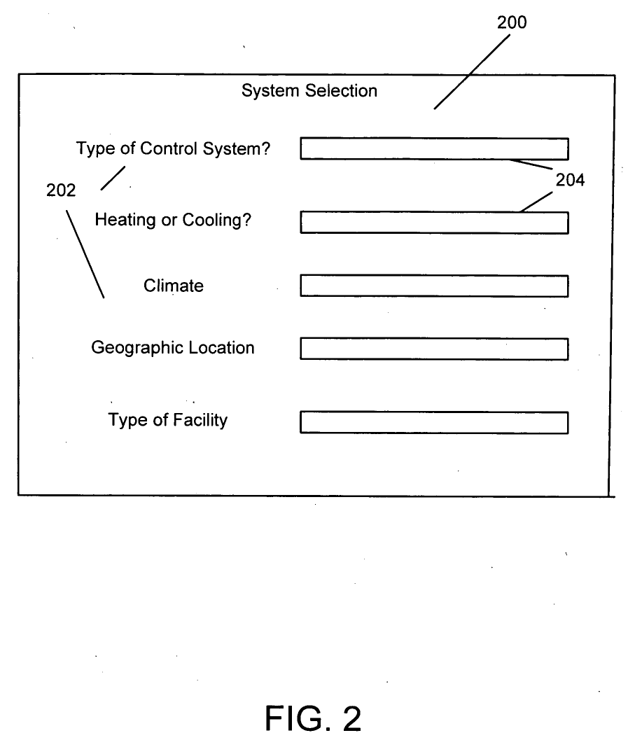

As mentioned above, user interface 104 and user interface logic 116 are configured to generate and display interfaces or views to a user 102 to access system 100 and to facilitate the entry and manipulation of data. Using system 100, a user 102 may configure aspects of a building automation control system (e.g., control diagrams) using various high level interfaces (or views) in conjunction with database 118. For example, during the configuration/engineering phase, a user may be presented with one or more system selector tools (e.g., a wizard or selection tree) via user interface 104. FIG. 2 illustrates an exemplary system selector tool in accordance with an embodiment. System selector tool 200 facilitates the receipt of information regarding a building automation control system a user wishes to configure and implement. System selector tool 200 is configured to present a series of questions/options 202 to receive information or data from a user regarding system specifications and needs. System selector tool 200 also includes data entry fields 204 associated with the questions/options 202. In an alternative embodiment, the system selector tool may be presented in the form of a selection tree. System selector tool 200 may be presented to a user who selects to access configuration/engineering logic 110 (shown in FIG. 1). In an alternative embodiment, a palette interface or view is provided via user interface 104. The palette includes, for example, high level equipment icons (e.g., a generic control system, fan, valve, etc.) which may be “dragged and dropped” onto a system drawing by a user.

Returning to FIG. 1, configuration/engineering logic 110 is configured to design various aspects of a building automation control system including hardware, control systems (e.g., the programming or control logic executed by controllers to control the system), customer interfaces and network configuration. Preferably, a complete system includes at least 1) a hardware diagram(s) with associated wiring diagrams, bill of materials, schedules, etc., 2) a control flow diagram that shows the software that controls the mechanical system and 3) a customer/operator interface that allows operators to interact with an installed building automation system. Configuration/engineering logic 110 uses data input from the system selector (or palette interface), predefined preferences associated with, for example, the user, in database 118, and a matching algorithm to automatically generate system or facility views (e.g., a hardware drawing, a control logic spreadsheet, a control diagram, a system diagram, a computer network diagram) that includes specific products, systems or equipment from the product/system library that may be used to implement the building automation control system. In other words, the configuration/engineering logic 110 is configured to automatically select and optimize the appropriate equipment (e.g., the specific type and part number of fan, the specific type and brand of controller) or control systems (e.g., control logic, control diagrams) to implement the building automation control system based on high level specifications provided by the user and the predefined preferences. Accordingly, a user configuring a system does not need to determine specific parts or system. In addition, configuration/engineering logic 110 may be used to automatically generate numerous other deliverables including a Bill of Materials (BOM), software outputs, drawings for sub-contractors (e.g., a wiring diagram for an electrician), drawings for contractor approval, test plans, orders for materials, etc. Such deliverables may be stored in database 118 and be available for subsequent tasks or phases.

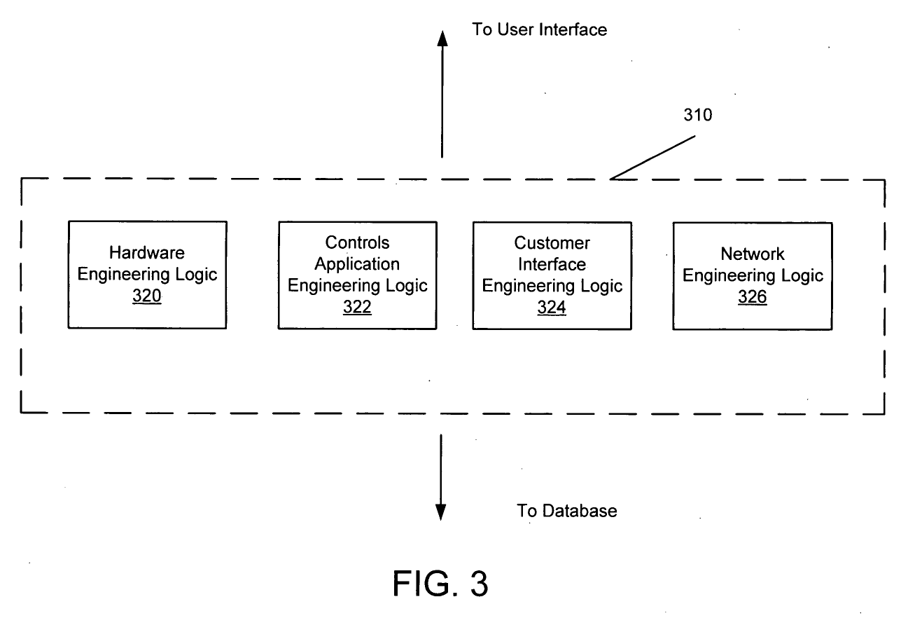

FIG. 3 is a lock diagram of the configuration/engineering logic in accordance with an embodiment. Configuration/engineering logic 310 includes hardware engineering logic 320, control applications engineering logic 322, customer interface engineering logic 324 and network engineering logic 326. As discussed above, configuration/engineering logic 310 in conjunction with database 118 (shown in FIG. 1), general high level information received via a system selector tool from a user, and predefined pre-defined preferences, automatically selects specific parts/systems from the product/system library and generates various views, drawings and deliverables regarding the desired building automation control system. For example, hardware engineering logic 320 may be used to generate mechanical views with the specific selected parts, assemblies or equipment. In another example, control applications engineering logic 322 may be used to generate control diagrams with the specific selected control system (or programming logic). Each control system or diagram in database 118 may represent a control program. Once parts/systems are selected and view are generated, the database 118 (shown in FIG. 1) is automatically populated with the details of the configured systems. This information is then available to all subsequent phases or tasks. The various elements of configuration/engineering logic 310 may also be used to view, change or manipulate aspects of the configured system.

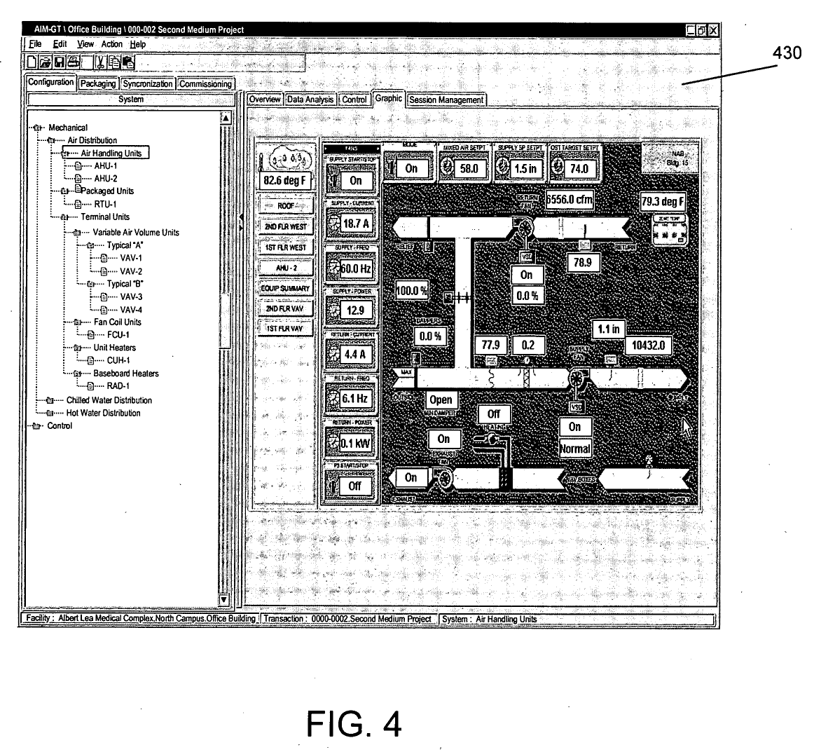

Hardware engineering logic 320 is configured to provide a means to describe the mechanical equipment for a given system or subsystem within a facility. Hardware engineering logic 320 provides different graphical and non-graphical views of facility information including the hardware systems, hardware assemblies, components under the assemblies, parts, equipment, etc. Hardware views may be graphical interfaces to the mechanical equipment associated with a given system within a facility. FIG. 4 is an exemplary hardware diagram view in accordance with an embodiment. View 430 shows assemblies, parts and equipment for an exemplary air distribution system. Returning to FIG. 3, hardware engineering logic 320 is also configured to allow a user to modify, select, add, and remove parts or assemblies in the various views provided for configured systems. A user may also modify details, for example, modify the part number of a device. When changes are made to a view, parts, etc., the changes are automatically stored in the database 118 (shown in FIG. 1) and changes to other views of the hardware engineering logic 320 as well as views generated by other elements of configuration/engineering phase may be made automatically based on the new information. Hardware engineering logic 320 may also generate and allow a user to edit other deliverables such as bills of material, orders, drawings, diagrams (e.g., a wiring diagram), schedules, etc. As mentioned above, the information for these deliverables are stored in the common database 118 and any changes or modifications to the data are automatically stored in database 118. Accordingly, this data is available to other phases of configuring and implementing the building automation control system.

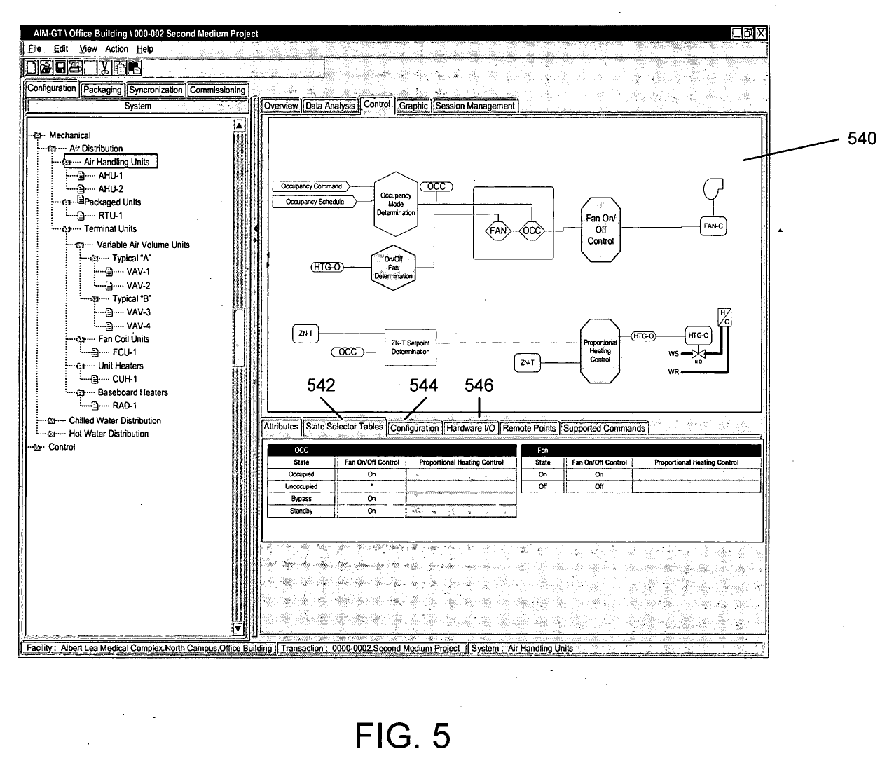

Control applications engineering logic 322 is configured to provide graphic or non-graphic (e.g., a spreadsheet) representations or views of the controls systems (i.e., the programming logic) and the controllers that execute the control logic. Programming logic is used to control the equipment and systems of the building automation control system. The control systems described the software or control program for a system. FIG. 5 is an exemplary control diagram view in accordance with an embodiment. View 540 includes connected blocks that represent the inputs, outputs, state generators, logic, state selectors, etc. for a control system. View 540 illustrates the control strategy for a selected system. View 540 also includes a state selection table 542, a configuration table 544 and a hardware input/output table 546. In an alternative embodiment, the control systems/control logic may be presented in a spreadsheet format. Returning to FIG. 3, control applications engineering logic 322 is also configured to allow a user to edit the control systems. Any changes made are automatically stored in database 118 (shown in FIG. 1). In addition, a user may use control applications engineering logic 322 to upload/download the control system to a controller and simulate the control system. Once a control system is created and stored in the common database, the programming logic may then be uploaded or downloaded into various controllers during a subsequent installation phase. In addition, a simulation capability allows the control diagrams to be tested in selected systems prior to installation. Any tests created or selected may be stored in the common database 118 and be accessed in a subsequent commissioning phase.

Customer interface engineering logic 324 is configured to generate a customer graphic interface of the final system and subsystems that may be used by an operator of the building automation control system to view, interact with and control the system equipment. Accordingly, customer graphic interface acts as an interface between an operator and the building automation control system installed in a facility. The customer graphic interface is generated based on the system information in database 118 (shown in FIG. 1). In one embodiment, when a change is made to a mechanical or control system (e.g., using hardware engineering logic 320 or control applications engineering logic 322), the customer graphic interface may be automatically change to reflect the new system information. The customer graphic interface created by customer interface engineering logic 324 is stored in database 118.

Network engineering logic 326 is configured to create a network topology (e.g., the computer network on which the system runs) for the building automation control system for a facility. Views may be generated that provided a user with a logical view of the facility network (e.g., trunk wiring). In addition, a user may use network engineering logic 326 to edit and modify the network topology. Network topology views may utilize data regarding the building automation control system stored in database 118. the network topology (and any changes) is stored in database 118.

Returning to FIG. 1, packaging logic 112 is coupled to database 118 and is configured to create deliverables that are needed for the installation phase of the building automation control system. For example, packaging logic may utilize system information from database 118 to generate packages of materials such as bills of material, orders, drawings, diagrams (e.g., a wiring diagram), schedules, etc. Database 118 may also include pre-configured reports that may be used by the packaging logic 112. Commissioning logic 114 is coupled to database 118 and is configured to perform verification and validation testing to ensure that various systems and subsystems of an installed building automation control system. An exemplary commissioning method and system is described in co-pending U.S. patent application Ser. No. 10/841,107, titled “Method and Apparatus for Assessing Performance of an Environmental Control System, filed May 7, 2004, herein incorporated by reference in its entirety. Views of the facility information used during configuration may also be accessed and used during the commissioning phase. In addition, as mentioned above, any tests created or selected during configuration of the control system be accessed during the commissioning phase. Commissioning logic 1145 may also be used to generate performance reports.

As noted above, embodiments within the scope of the present invention include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devise, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions.

In some embodiments, the present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer executable instructions, associated data structures, and program modules represent examples of program code for executing steps of the methods disclosed herein. The particular sequence of such executable instructions or associated data structures represents examples of corresponding acts for implementing the functions described in such steps.

The present invention in some embodiments, may be operated in a networked environment using logical connections to one or more remote computers having processors. Logical connections may include a local are network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devise that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention may include a general purpose computing device in the form of a conventional computer, including a processing unit, a system memory, and a system bus that coupled various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-Rom or other optical media. The drives and their associated computer-readable media provide nonvolatile storage of computer-executable instructions, data structures, program modules and other data for the computer.

It should be noted that although the flow charts provided herein show a specific order of method steps, it is understood that the order of these steps may differ from what is depicted. Also two or more steps may be performed concurrently or with partial concurrence. Such variation will depend on the hardware and software systems chosen and on designer choice. It is understood that all such variations are within the scope of the invention. Software and web implementations of the present invention coupled be accomplished with standard programming techniques with rule based logic and other logic to accomplish the various database searching steps, correlation steps, comparison steps and decision steps. It should also be noted that the work “component” as used herein and in the claims is intended to encompass implementations using one or more lines of software code, and/or hardware implementations, and/or equipment for receiving manual inputs.

It is important to note that the above-described preferred and alternative embodiments are illustrative only. Although the invention has been described in conjunction with specific embodiments thereof, those skilled in the art will appreciate that numerous modifications are possible without materially departing from the novel teachings and advantages of the subject matter described herein. It should be noted that all numbers discussed above in the examples and illustrated in the figures are for purposes of explanation only and are not to be construed as limiting in any way. The order or sequence of any process or method steps may be varied or re-sequenced according to alternative embodiments. In the claims, any means-plus-function clause is intended to cover the structures described herein as performing the recited function and not only structural equivalents but also equivalent structures. Accordingly, these and all other such modifications are intended to be included within the scope of the present invention. Other substitutions, modifications, changes and omissions may be made in the design, operating conditions and arrangement of the preferred and other exemplary embodiments without departing from the spirit of the present invention.

What is claimed is:

1. A system for configuring a building automation control system, the system comprising:
a user interface configured to receive system data regarding specifications for the building automation control system from a user;
configuration logic coupled to the user interface and configured to generate at least one view of the building automation control system;
packaging logic coupled to the user interface and configured to generate at least one deliverable; and
a common data storage system coupled to the configuration logic and the packaging logic, the data storage system begin commonly accessible to the configuration logic and the packaging logic and including a set of predefined preferences;
wherein the at least one view is generated based on at least the system data and the predefined preferences.

2. A system according to claim 1, wherein the at least one deliverable is, generated based on at least the system data and the predefined preferences.

3. A system according to claim 1, wherein the configuration logic comprises hardware engineering logic configured to generate hardware system views of the building automation control system.

4. A system according to claim 1, wherein the configuration logic comprises control applications engineering logic configured to generate control systems for the building automation control system.

5. A system according to claim 1, wherein the configuration logic comprises customer interface engineering logic configured to generate at least one customer interface for the building automation control system.

6. A system according to claim 1, wherein the configuration logic comprises network engineering logic configured to generate a network topology for the building automation control system.

7. A system according to claim 1 wherein the user interface includes a system selector tool configured to facilitate receipt of the system data from the user.

8. A system according to claim 1, wherein the user interface includes a palette interface configured to facilitate receipt of the system data from the user.

9. A system for configuring a building automation control system, the system comprising:
a user interface configured to receive system data regarding specifications for the building automation control system from a user;
control applications engineering logic coupled to the user interface and configured to generate control systems for the building automation control system;
customer interface engineering logic coupled to the user interface and configured to generate at least one customer interface for the building automation control system; and
a common data storage system coupled to the control applications engineering logic and the customer interface engineering logic, the data storage system begin commonly accessible to the configuration logic and the packaging logic and including a set of predefined preferences;
wherein the control systems are generated based on at least the system data and the predefined preferences.

10. A system according to claim 9, wherein the control systems include control diagrams.

11. A system according to claim 9, further comprising hardware engineering logic coupled to the common data storage system and configured to generate hardware system views of the building automation control system.

12. A system according to claim 9, further comprising network engineering logic coupled to the common data storage system and configured to generate a network topology for the building automation control system

13. A system according to claim 9, wherein the user interface includes a system selector tool configured to facilitate receipt of the system data from the user.

14. A system according to claim 9, wherein the user interface includes a palette interface configured to facilitate receipt of the system data from the user.

15. A system according to claim 9, wherein the control systems include a control logic spreadsheet for presentation to the user.
